(19) United States
(12) Patent Application Publication
(10) Pub. No.: US 2016/0157308 A1
(43) Pub. Date: Jun. 2, 2016

(54) LED DISPLAY SYSTEM

(71) Applicant: ELECTRONICS RESEARCH PTY LTD, Seven Hills NSW (AU)

(72) Inventor: Michael Sick Cheong Tsang, Auburn NSW (AU)

(21) Appl. No.: 15/015,915

(22) Filed: Feb. 4, 2016

Related U.S. Application Data
(63) Continuation of application No. 13/496,734, filed on Jul. 13, 2012, now abandoned.

(30) Foreign Application Priority Data
Sep. 16, 2009 (AU) 2009904486

(51) Int. Cl. H05B 33/08

(52) U.S. Cl. CPC H05B 33/089; H05B 33/0845

(57) ABSTRACT

The present invention relates to a LED display system (10) including a panel (12) and detecting means (20). The LED display system (10) also includes means (14) for selectively varying power supply to the panel (12). The panel (12) has an array of LEDs. The detecting means (20) is adapted to activate or deactivate one or more of the LEDs.

### CROSS-REFERENCE TO RELATED APPLICATIONS

This application is a continuation of U.S. patent application Ser. No. 13/496,734, filed Jul. 13, 2012; which application is a U.S. National Stage Application, filed under 35 U.S.C. §371, of International Application No. PCT/AU2010/001210, filed Sep. 16, 2010, which application further claims priority to Australian Application No. 2009904486, filed Sep. 16, 2009; the contents of all of which as are hereby incorporated by reference in their entirety.

### BACKGROUND

### Technical Field

This invention relates to a LED display system, particularly but not exclusively, for installation in one or more traffic light lanterns.

The majority of traffic light lanterns currently in use are fitted with a quartz halogen light bulb, or even less efficient incandescent light globes with associated reflector and lens. As traffic lights are required to be in continuous operation all the time and the average life span of a halogen globe is limited to approximately 5000 hours, a regimen of continuous bulb replacement has to be implemented.

Although the housing of a traffic lantern housing is very robust with an average life expectancy of twenty years, the quartz halogen aspect contained within the housing is fairly high maintenance as it is not fully sealed and hence the reflector and lens surface need to be cleaned at regular intervals. Also, the fine element within the bulb is very easy to break when it is bumped. Therefore there has been an attempt to replace the quartz halogen light bulbs with light emitting diodes (LEDs) which have a solid-state light source.

For the above reasons, quartz halogen traffic lights in most if not all countries around the world are being replaced with LEDs. At present, the only way to achieve this is by replacing each lantern in its entirety, not just the globe contained therein. This typically involves dismantling everything from a pole to enable installation of the replacement and unavoidably causes inconvenience due to the need to take one or more of the following measures: switching off an entire set of lights at a relevant intersection, allocating traffic wardens to direct traffic; employing heavy duty lifting equipment and blocking off affected traffic lanes.

Also, quartz halogen lantern housings have a life expectancy of twenty years and are generally in good condition when they are replaced. Discarding these lantern housings is a gross waste of resources, let alone being poor ecological practice.

Despite the above, existing LEDs used to replace quartz halogen lights have their own problems too in that they are susceptible to failure due to overheating, particularly during summer.

It is an object of the present invention to provide a LED display system which may overcome or ameliorate the above problems or which will at least provide a useful alternative.

### BRIEF SUMMARY

According to one aspect of the present invention, there is provided a LED display system including: a panel having an array of LEDs; and detecting means adapted to detect power consumption and/or brightness of one or more of the LEDS and deactivate the one or more of the LEDs when the detected power consumption and/or brightness falls to a selected level.

In a preferred embodiment, the panel is a printed circuit board on which the LEDs are mounted.

Preferably, the LED display system also includes means for selectively varying power supply to the panel. The power varying means may include one or more driver circuits adapted to be controlled by or incorporated in a microprocessor. The power varying means may be adapted to operate on a constant current. The power varying means is preferred to be adapted to empower one or more panels of different sizes.

Each driver circuit is preferred to be capable of varying the brightness of the LEDs at a predetermined time or for a predetermined period of time as desired. For instance, the driver circuit may be capable of gradually dimming the LEDs in accordance with a stepped profile. Preferably, if one or more of the LEDs have failed, the driver circuit may be capable of maintaining the remainder of the LEDs activated at a desired level of brightness. More preferably, when more than a predetermined percentage of the LEDs have failed, the driver circuit is adapted to deactivate the remainder of the LEDs. Even more preferably, the predetermined percentage is 20%.

The driver circuit may be adapted to cause flashing of the LEDs for variable lengths of time.

In a preferred embodiment, the detecting means may be in communication with the microprocessor. The detecting means may include or be connected to a push button which when activated is adapted to cause flashing of the LEDs for a predetermined period of time. Optionally, the detecting means includes one or more of the following: a heat detecting device; a motion detecting device or sound detecting device. For instance, the motion detecting device may include a trip wire which when triggered is adapted to activate an electronic display board for road users.

The microprocessor may be programmed to enable various parameters to be set and changed for activation and deactivation of the driver circuit.

The microprocessor may be programmed to operate multiple colour LEDs by controlling more than one driver circuit. Each driver circuit is preferred to be responsible for the operation of the LEDs on a selected panel.

The LED display system is preferred to be powered by an AC or DC power source.

Preferably, the power source is a printed circuit board (PCB) heat sinked LED driver. Optionally, the LED display system includes an additional drive circuit adapted to control a larger or an additional LED panel.

Optionally, the printed circuit board includes a dual in-line package (DIP) switch adapted to customise the behaviour of the LED for specific situations or to control additional software functions.

### BRIEF DESCRIPTION OF THE SEVERAL VIEWS OF THE DRAWING(S)

The invention may be better understood from the following non-limiting description of a preferred embodiment, in which:

FIG. 1 is a schematic plan view of an underside of a LED display system in accordance with the present invention;

FIG. 2 is a circuit diagram illustrating the driver circuits and microprocessor of the LED display system of FIG. 1; and

FIG. 3 is a diagram being a simplified version of FIG. 2.

### DETAILED DESCRIPTION OF VARIOUS EMBODIMENTS

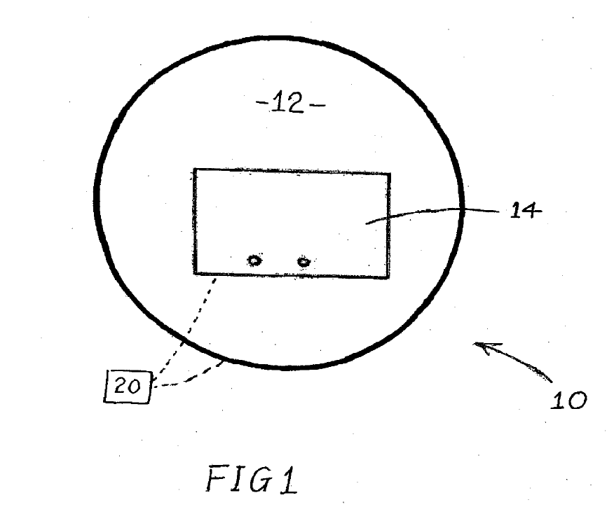

Referring to FIG. 1, a LED display system 10 includes a panel 12 having an array of LEDs (located on the other side of the panel 12 and hence not visible) and means for selectively varying power supply to the panel 12. In this embodiment, the panel 12 is a printed circuit board on which the array of LEDs are mounted.

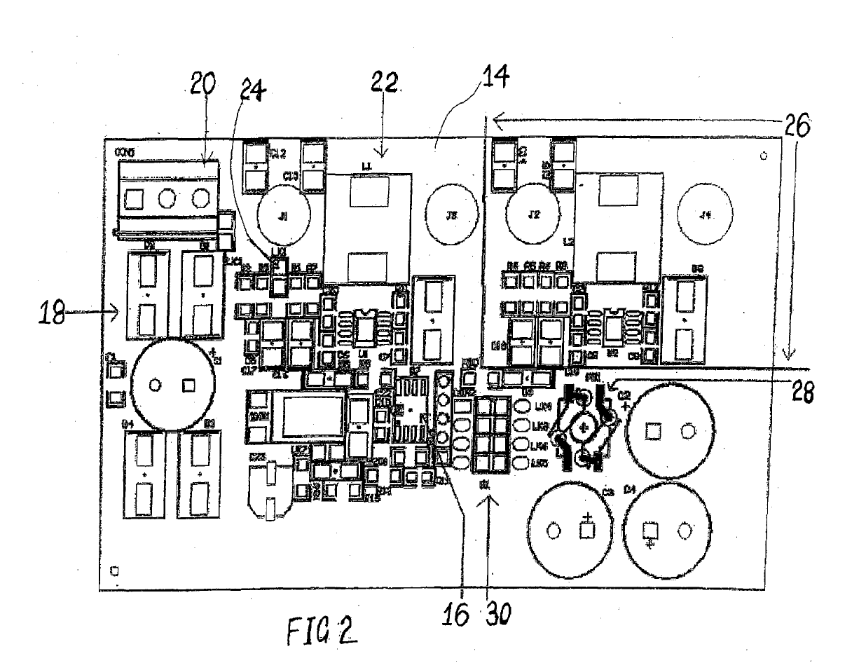

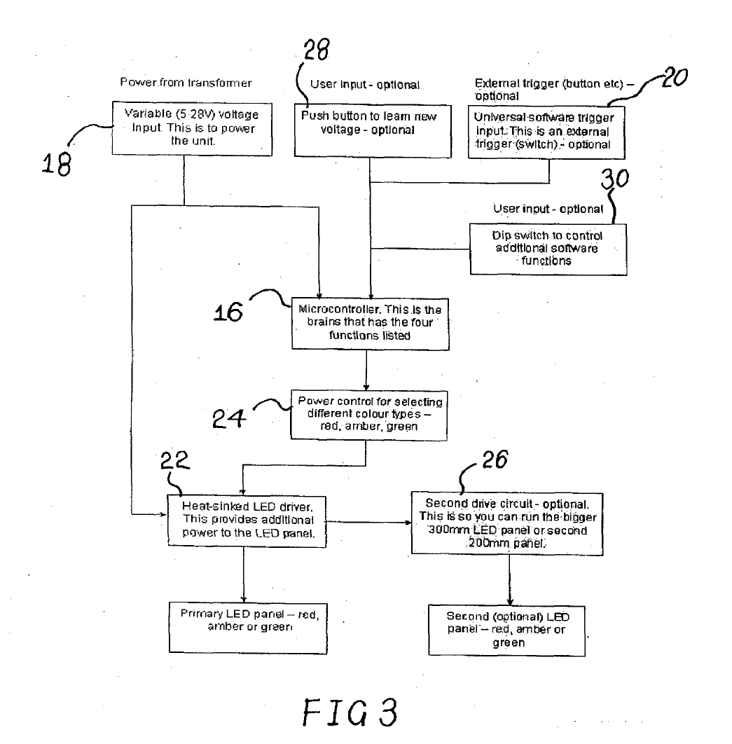

Turning to FIGS. 2 and 3, the power varying means includes driver circuits incorporated in a microprocessor. The microprocessor is in the form of a controller card 14 which is electronically connected to the panel 12 (refer to FIG. 1). The controller card 14 operates on a constant current and is capable of empowering panels of different sizes. In the present embodiment, each panel is connected to and driven by one controller card 14. The controller card 14 is screwed onto the panel 12 via metal spacers. This arrangement both secures and powers the LED panel 12 yet keeps the number of physical parts to the minimum.

The controller card 14 includes a microchip 16 with a driver circuit capable of performing various primary functions. The driver circuit is capable of supplying power to panels of two different sizes, namely 200 mm and 300 mm in diameter. The power output is increased for a larger sized panel.

The LED display system of the present invention also includes a detecting means for activating or deactivating the LEDs. In the present embodiment, the detecting means is in the form of a push button (not shown) which is in communication with the microprocessor. When activated by a pedestrian, the push button sends a signal to the driver circuit which causes flashing of the LEDs for a predetermined period of time. It is contemplated that in place of or addition to the push button, the detecting means may include one or more of the following: a heat detecting device; a motion detecting device or sound detecting device. For instance, a motion detecting device may include a trip wire using trigger input 20 which is located at a certain distance from a set of traffic lights. With such an arrangement, a vehicle approaching the set of traffic lights will trigger the trip wire which will send an electronic signal to the driver circuit which will in turn activate an electronic display board provided to generate a visual signal for the driver of the vehicle. The visual signal may be a speed limit or a warning sign indicating the occurrence of an accident ahead.

The microprocessor includes a programmable trigger input 20. The input 20 is to be generated by an external trigger such as the push button described above and is programmed to send an electronic signal to the microchip 16 for activating or adjusting the brightness of the LEDs.

The microprocessor is also capable of controlling the driver circuit to cause flashing of the LEDs for variable lengths of time. This is beneficial in that it is usually desirable for wide and long roads to have signs capable of flashing for a longer period of time to render the signs more noticeable to road users.

The LED display system 10 is powered by a power source 18 capable of generating either of alternative and direct current (AC or DC) as desired. The power source 18 is a printed circuit board (PCB) being heat sink cooled to be efficient in dissipating and dispersing heat to reduce the likelihood of overheating of the LEDs. The LED display system 10 can be empowered with either a 5-28V AC or 12V DC power source. This allows the traffic light to be powered by a transformer supplying the conventional 240V AC, a battery or solar panel. This is advantageous in providing a traffic management system with enhanced versatility and portability.

In this embodiment, a printed circuit board (PCB) heat sinked LED driver 22 is controlled by the microchip 16 and also electronically connected to the power source 18.

The heat sink is provided and designed to dissipate heat efficiently to reduce the likelihood of overheating of the LEDs. The heat sinked LED driver 22 is provided to supply additional power to the panel 12.

The microprocessor also includes an output section link 24 which is controlled by the microchip 16 to control power supply to a selected or designated driver circuit for one of three colours, namely red, amber and green. The microprocessor is programmed to operate multiple colour LEDs by controlling three driver circuits, each of the driver circuits being responsible for the operation of the LEDs responsible for displaying a selected colour on a selected panel.

Furthermore, the microprocessor has an additional driver 26 which is in communication with the LED driver 22. The additional driver 26 is provided to control the larger 300 mm panel described above or an additional LED panel. The additional LED panel may be customised for displaying for example signs for cyclists or speed limit signs.

Optionally, the microprocessor includes a push button 28 which is designed to learn a new voltage whenever the button is pushed and generate a signal for the microchip 16 to adjust the brightness of the LEDs.

The microprocessor is programmed to vary the brightness of the LEDs at a predetermined time or for a predetermined period of time as desired. For instance, the driver circuit is capable of progressively dimming the LEDs in accordance with a stepped profile. When one or more of the LEDs have failed, the driver circuit maintains the remainder of the LEDs active at a desired level of brightness. Additionally, when more than a predetermined percentage of the LEDs have failed, the driver circuit is programmed to deactivate the remainder of the LEDs.

In addition to the above, the microprocessor may be programmed remotely to enable various parameters to be set and changed for activation and deactivation of the driver circuit.

The microprocessor has a dual in-line package (DIP) switch 30 electronically connected to the microchip 16. The DIP switch 30 is designed to customise the behaviour of the LED for specific situations or to control additional software functions.

It should be noted that the LED display system of the present invention can be retrofitted into an existing traffic lantern housing to replace halogen globes.

Now that a preferred embodiment of the present invention has been described in some detail, it will be apparent to a skilled person in the art that the LED display system may offer at least the following advantages:

1. it eliminates the need of a great deal of physical componentry thereby enhancing reliability and reducing energy wastage;

2. it is capable of driving panels of different sizes and hence reduces production and assembly costs but increases versatility;

3. it enables a traffic light aspect to be software driven allowing greater flexibility with respect to functionality and operability;

4. it substantially reduces the likelihood of LED failure due to overheating; and

5. it is retrofittable to an existing traffic light lantern to replace halogen globes.

Those skilled in the art will appreciate that the invention described herein is susceptible to variations and modifications other than those specifically described. All such variations and modifications are to be considered within the scope and spirit of the present invention the nature of which is to be determined from the foregoing description.

Industrial Applicability

The LED display system of the present invention is industrially applicable in that it is retrofittable to an existing traffic light lantern enabling a traffic light aspect to be software driven, allowing greater flexibility with respect to functionality and operability. It also substantially reduces the likelihood of LED failure due to overheating. Furthermore, it is capable of driving panels of different sizes eliminates the need of a great deal of physical componentry.

What is claimed:

1. A traffic light LED display system comprising:
a driver circuit operable to supply power to a panel comprising an array of LEDs, the LEDs in the array being powered such that when one or more of the LEDs fail the other LEDs in the array remain operational; and
a microprocessor operable to determine a number of LEDs that have failed in the array, the microprocessor further operable to control the driver circuit to deactivate the remaining operational LEDs in the array when the determined number of failed LEDs exceeds a predetermined amount,
wherein the microprocessor is further operable to control the driver circuit to dim the LEDs in accordance with a dimming profile at a predetermined time.

2. The traffic light LED display system of claim 1, wherein the panel is a printed circuit board on which the LEDs are mounted.

3. The traffic light LED display system of claim 1, wherein the driver circuit is controllable for selectively varying power supply to the panel.

4. The traffic light LED display system of claim 1, wherein the driver circuit is incorporated in a microprocessor.

5. The traffic light LED display system of claim 1, wherein the driver circuit is configured to operate on a constant current.

6. The traffic light LED display system of claim 1, wherein the driver circuit is configured to empower one or more panels of different sizes.

7. The traffic light LED display system of claim 1, wherein the driver circuit is controllable to gradually dim the LEDs in accordance with a stepped profile.

8. The traffic light LED display system of claim 3, wherein when one or more but less than the predetermined amount of LEDs fail, the driver circuit is controllable to maintain the remainder of the operational LEDs at a predefined level of brightness.

9. The traffic light LED display system of claim 1, wherein the predetermined amount is approximately 20% of the total number of LEDs in the array.

10. The traffic light LED display system of claim 1, wherein the microprocessor is electronically communicable with a push button and wherein the microprocessor is further operable to control the driver circuit to cause flashing of the LEDs for a predetermined period of time, responsive to the push button being pressed.

11. The traffic light LED display system of claim 1, wherein the microprocessor is programmable so as to enable various parameters to be set and changed for activation and deactivation of the driver circuit.

12. The traffic light LED display system of claim 1, wherein the microprocessor is programmable to operate multiple colour LEDs by controlling more than one driver circuit.

13. The traffic light LED display system of claim 1, further comprising a power source operable to provide power to the microprocessor and driver circuit, wherein the power source comprises a printed circuit board (PCB) heat sinked LED driver.

14. The traffic light LED display system of claim 13, wherein the printed circuit board includes a dual in-line package (DIP) switch adapted to customise the behaviour of the LED.
